(19) United States
(12) Patent Application Publication
(10) Pub. No.: US 2012/0275987 A1
(43) Pub. Date: Nov. 1, 2012

(54) SYSTEMS AND METHODS FOR CARBON SEQUESTRATION OF SYNTHESIS GAS

(76) Inventors: MICHAEL D. HIZA, Story, WY (US); Philip Brlan Tuet, Milpitas, CA (US); Manoj R. Som, Cupertino, CA (US); Betty Kong Ling Pun, San Jose, CA (US)

(21) Appl. No.: 13/446,294

(22) Filed: Apr. 13, 2012

Related U.S. Application Data
(60) Provisional application No. 61/479,153, filed on Apr. 26, 2011.

(51) Int. Cl. F23L 7/00; C01D 7/14; C01F 11/18; B01J 19/00; C01B 31/24

(52) U.S. Cl. 423/425; 422/187; 423/419.1; 423/430; 431/2

(57) ABSTRACT

Provided are methods for sequestering carbon dioxide from a synthesis gas to provide a gaseous and an aqueous product. A recovery method and system for combusting the gaseous product and utilizing the aqueous product is provided. Methods and systems are described for utilizing the aqueous product in an electrochemical or a precipitation reaction. Compositions of sequestered carbon dioxide are provided.

### CROSS-REFERENCE TO RELATED APPLICATIONS

This application claims priority to U.S. Provisional Patent Application No. 61/479,153, filed Apr. 26, 2011, which is incorporated herein by reference in its entirety.

### BACKGROUND

Methods and systems to maximize carbon sequestration are needed. Improved methods and systems for gas-liquid contact are needed to insure that the carbon sequestration methods are economical.

### SUMMARY

Provided are methods for contacting a synthesis gas stream with a reactive solution to form a product solution and a product gas with a reduced carbon dioxide concentration. The product solution may comprise carbonate, bicarbonate or any combination thereof and a portion of the product solution may be utilized as a catholyte in an electrochemical reaction. The product gas may be processed or combusted. Processing the product gas may include reacting the gas in a synthesis reaction. In some embodiments the reactive solution is alkaline solution from an electrochemical reaction. In some embodiments a synthesis gas stream may be contacted with an alkaline solution comprising hydroxide to form a product solution and a product gas with a reduced carbon dioxide concentration wherein the product solution comprises carbonate, bicarbonate or any combination thereof followed by combusting or processing the product gas. In some embodiments a synthesis gas stream that contains a first portion of CO₂ may be contacted with a first reactive solution to form a first product solution and a first product gas with a reduced carbon dioxide concentration wherein the product solution comprises carbonate, bicarbonate or any combination thereof. The product gas may be combusted to produce a waste gas comprising second portion of CO₂ that may be contacted with second reactive solution to form a second product gas with a CO₂ concentration lower than the CO₂ concentration of the waste gas and a second product solution that comprises carbonate, bicarbonate or any combination thereof. The first and second reactive solutions may be alkaline, they may be the same or they may be different. In some embodiments the first alkaline solution may comprise carbonates, and the second may comprise hydroxides.

In some embodiments the synthesis gas may be shifted prior to contacting with the reactive solution or in the alternative, the synthesis gas may not be shifted prior to contact with the reactive solution. In some embodiments the synthesis gas may also comprises a first H₂S or COS concentration and contacting the reactive solution forms a product gas with a second H₂S or COS concentration less than the first H₂S concentration. In some embodiments the reactive solution is an alkaline solution comprises carbonates and the second alkaline solution comprises ⁻OH. In some embodiments combusting the product gas generates electrical energy and a waste gas that has a carbon dioxide concentration of less than the synthesis gas. In some embodiments the reactive solution is an alkaline solution formed from an electrochemical process that does not produce chlorine gas. In some embodiments the alkaline solution comprises NaCO₃. In some embodiments the electrochemical reaction comprises applying a voltage across an anode and a cathode, wherein the anode is in contact with a first electrolyte and the cathode is in contact with a second electrolyte. In some embodiments the electrochemical reaction comprises migrating ions across a GDE disposed between the first electrolyte and the second electrolyte. In some embodiments the electrochemical reaction comprises producing hydroxide ions in the second electrolyte without forming oxygen or chlorine gas at the anode. In some embodiments the electrochemical reaction comprises producing hydrogen gas at the cathode. In some embodiments the electrochemical protocol employs a voltage of 1.2 V or 0.6 V or less.

In some embodiments forming a product solution from the synthesis gas stream and a reactive solution consumes 75% or 50% or 30% or less of the amount of energy generated during combusting the product gas. In some embodiments the method comprises producing a carbonate-containing precipitation material from the product solution. In some embodiments producing a carbonate-containing precipitation material comprises subjecting the carbonate-containing composition to precipitation conditions to produce a carbonate-containing precipitation material and depleted aqueous composition. In some embodiments the method further comprises separating the carbonate-containing precipitation material from the depleted aqueous composition. In some embodiments the carbonate-containing precipitation material comprises NaHCO₃, Na₂CO₃, CaCO₃, MgCO₃, Na₃(HCO₃)(CO₃) or any combination thereof. In some embodiments the carbonate-containing precipitation material comprises aragonite, vaterite, amorphous calcium carbonate, trona, or any combination thereof. In some embodiments the method further comprises processing the carbonate-containing precipitation material to produce a building material. In some embodiments the building material may be selected from the group consisting of hydraulic cement, a supplementary cementitious material or aggregate.

In some embodiments systems for separating carbon dioxide from a synthesis gas stream are disclosed that comprise a gasifier configured to produce a synthesis gas and operably connected to a gas-liquid absorption system that comprises an inlet for a reactive solution, an outlet for a product gas with a reduced carbon dioxide content and an outlet for sequestered carbon dioxide wherein the gas-liquid absorption system is operably connected to an electrochemical system.

In some embodiments the electrochemical system is configured to operate at a voltage of 0.6 or less. In some embodiments the electrochemical system comprises a conduit system configured to transport the reactive solution from the electrochemical system to the gas-liquid absorption system. In some embodiments a precipitation system is operably connected to the gas-liquid absorption system. In some embodiments the electrochemical system comprises an anode in contact with a first electrolyte and a cathode in contact with a second electrolyte. In some embodiments the electrochemical system is configured to apply a voltage across the anode and cathode to produce hydroxide ions in the second electrolyte without forming oxygen or chlorine at the anode. In some embodiments the second electrolyte comprises sodium chloride. In some embodiments the system is configured to consume 60% or 30% or 14% or less of the amount of energy generated to produce the synthesis gas stream. In some embodiments the system further comprises a detector configured to determine energy consumption of the system. In some embodiments the system further comprises one or more conduits for conveying the sequestered carbon dioxide to a sequestration location. In some embodiments the sequestration location is a subterranean formation. In some embodiments the system further comprises a carbonate-compound production station configured to produce a carbonate-containing precipitation material and depleted aqueous composition. In some embodiments the carbonate-compound production station comprises a liquid-solid separator.

### DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a flow diagram of embodiments of this invention.

FIG. 2 illustrates a schematic diagram of an IGCC plant of this invention.

FIG. 3 illustrates a flow diagram of an embodiment of this invention.

FIG. 4 illustrates a schematic diagram of an electrochemical system of this invention.

### DESCRIPTION

Methods and systems are disclosed for the sequestration of carbon dioxide from a synthesis gas prior to the combustion or processing of the synthesis gas. The products of the sequestration reaction may include a synthesis gas with a reduced carbon dioxide content that may be processed further and an aqueous product that comprises bicarbonate, carbonate, carbonic acid, dissolved carbon dioxide or any combination thereof that may be processed further as well. The methods and systems of this invention advantageously allow for the utilization of both the reduced CO₂ synthesis gas product and the sequestered carbon dioxide product to form either useful products or feedstocks or energy. In some embodiments the methods and systems disclosed provide for the use of reaction products in an electrochemical reaction or in a precipitated product. In some embodiments the methods and systems disclosed provide for the sequestration of carbon dioxide by a proton removing agent such as sodium hydroxide or sodium carbonate. In some embodiments divalent cations and/or monovalent cations may be combined with sequestered carbon dioxide to form a precipitated carbonate product. The methods and systems here may provide for sequestered carbon dioxide from a syntheses gas to be utilized in products that are useful for a variety of purposes, (e.g., building materials, agricultural enchantments, or materials used in paper processing).

Before the invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are now described.

All publications, patents, and patent applications mentioned in this specification are incorporated herein by reference to the same extent as if each individual publication, patent, or patent application was specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method can be carried out in the order of events recited or in any other order, which is logically possible.

Materials used to produce compositions of the invention are described in a section with particular attention to sources of CO₂, divalent cations, and proton-removing agents (and methods of effecting proton removal). A description of systems that may be used to sequester carbon dioxide is also provided. Methods for generating reactive carbon sequestering solutions are provided. Methods by which materials (e.g., CO₂, divalent cations, etc.) may be incorporated into compositions of the invention are described next. Subject matter is organized as a convenience to the reader and in no way limits the scope of the invention.

### Sequestration of Carbon Dioxide

As described in commonly assigned U.S. patent application Ser. No. 12/344,019, herein incorporated by reference in its entirety, carbon dioxide may be sequestered by dissolving the gas in an aqueous solution Eq. I to produce aqueous carbon dioxide. This may be converted to carbonic acid, which will dissociate into bicarbonate ions and carbonate ions in accordance with Eq. II, depending on the pH of the solution when hydroxide ions are added to the solution Eq. III. The conversion of carbonic acid into bicarbonate and carbonate may be accomplished through the addition of a proton-removing agent (e.g., a base) (III-IV). Chemically, aqueous dissolution of CO₂ may be described by the following set of equations:

CO₂(g) [symbol] CO₂(aq) (in the presence of water) (I)

CO₂(aq)+H₂O [symbol] H₂CO₃(aq) (II)

Conversion to bicarbonate may described by the following equations:

H₂CO₃(aq)+OH⁻(aq) [symbol] HCO₃⁻(aq)+H₂O (III)

CO₂(aq)+OH⁻(aq) [symbol] HCO₃⁻(aq) (IV)

In the methods described herein, at least some of the captured carbon dioxide may be converted to bicarbonate or carbonate ions through the addition of proton-removing agents. The proton removing agents may comprise monovalent or divalent cations.

As described in detail below, contacting the alkaline solution with a source of CO₂ may employ any suitable protocol, such as for example by employing gas bubblers, contact infusers, fluidic Venturi reactors, spargers, components for mechanical agitation, stirrers, components for recirculation of the source of CO₂ through the contacting reactor, gas filters, sprays, trays, or packed column reactors, and the like, as may be convenient.

Aspects of the invention include methods for contacting a reactive solution with a synthesis gas comprising carbon dioxide to sequester carbon dioxide in a carbon containing reaction product (e.g., an aqueous solution comprising carbonic acid, bicarbonate, carbonate or combination thereof). The reactive solution may comprise sodium hydroxide, potassium hydroxide, magnesium oxide or any combination thereof. The carbon containing reaction product may be a clear liquid or a precipitate. The reaction product, (e.g., the carbonic acid, bicarbonate, carbonate, carbonate composition) may further be contacted with a source of a divalent cations such as magnesium or calcium. In some embodiments of this invention the sequestered carbon dioxide may be contacted with a divalent cation to form a precipitate. In certain embodiments of the invention, a portion of reaction product produced by contacting carbon dioxide with an reactive solution may be placed in a storage location (e.g., in a in a subterranean site), effectively sequestering carbon dioxide in the form of any combination of a carbonic acid, bicarbonate and carbonate mixture. A portion of the reaction product material may be placed in a subterranean site and a portion may be further processed into a useful material.

“Alkaline solution” as used herein includes an aqueous composition which possesses sufficient alkalinity to remove one or more protons from proton-containing species in solution. Proton removing agents are discussed in greater detail below. The stoichiometric sum of proton-removing agents in the alkaline solution exceeds the stoichiometric sum of proton-containing agents expressed as equivalents or milliequivalents (mEq.). In some instances, the alkaline solutions of this invention have a pH that is above neutral pH (i.e., pH>7), e.g., the solutions may have a pH ranging from 7.1 to 12, such as 8 to 12, such as 8 to 11, and including 9 to 14. For example, the pH of one or more alkaline of the solution may be 9.5 or higher, such as 9.7 or higher, including 10 or higher. Contact of gases or liquids comprising carbon dioxide with a solution of this invention may convert the carbon dioxide to storage stable form such as a composition comprising carbonate, bicarbonate or any combination thereof.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra hereby incorporated by reference in its entirety.

### Materials

As described in further detail below, the invention involves the use of a synthesis gas containing CO₂, and one or more sources of carbon sequestering reagents. The materials may be used to produce compositions comprising carbonates, bicarbonates, or combinations thereof in addition to a synthesis gas with a reduced carbon dioxide content that is suitable for further processing.

### Carbon Dioxide

In some embodiments, methods of the invention include contacting a reactive solution with a synthesis gas stream comprising carbon dioxide to form a product comprising water, carbonic acids, dissolved carbon dioxide, bicarbonates, or carbonates, or any combination thereof. The synthesis gas may be made by any method such as steam reforming (e.g., steam methane reforming (SMR), auto thermal reforming (ATR)), transplant membrane reforming (e.g., ionic transplant membrane (ITM), hydrogen thermal membrane (HTM), oxygen thermal membrane (OTM)), partial oxidation, destructive distillation, thermal reforming, institutional gasification or any combination thereof. The gaseous stream may or comprise multiple components such as hydrogen, carbon monoxide, water, and one or more additional gases and/or other substances such as ash and other particulate material, sulfur and the like. In some embodiments, the gaseous stream is a synthesis gas that has undergone a shift reaction and has a substantially higher partial pressure of CO₂ than un-shifted synthesis gas or traditional flue gas. Gas streams comprising CO₂ include reducing streams such as syngas, shifted syngas, natural gas, hydrogen and the like (anything else?).

Thus, the pre-combustion or preprocessed synthesis gas streams may be suitable for methods and systems of this invention. In addition post combustion gas streams may be used in combination with methods of this invention. In some embodiments, waste streams produced by power plants that combust or process syngas (i.e., gas that is produced by the gasification of organic matter, for example, coal, biomass, etc.) may be used. In some embodiments, pre and post combustion streams from integrated gasification combined cycle (IGCC) plants are used. In some embodiments, waste streams from Heat Recovery Steam Generator (HRSG) plants are used to produce compositions in accordance with systems and methods of the invention.

While synthesis gas streams suitable for use in the invention contain carbon dioxide, such streams may, especially in the case of power plants that process fossil fuels (e.g., coal), may contain additional components such as water (e.g., water vapor), CO, NOₓ (mononitrogen oxides: NO and NO₂), SOₓ (monosulfur oxides: SO, SO₂ and SO₃), VOC (volatile organic compounds), heavy metals and heavy metal-containing compounds (e.g., mercury and mercury-containing compounds), and suspended solid or liquid particles (or both). Additional components in the gas stream may also include halides such as hydrogen chloride and hydrogen fluoride; particulate matter such as fly ash, dusts (e.g., from calcining), and metals including arsenic, beryllium, boron, cadmium, chromium, chromium VI, cobalt, lead, manganese, mercury, molybdenum, selenium, strontium, thallium, and vanadium; and organics such as hydrocarbons, dioxins, and polycyclic aromatic hydrocarbon (PAH) compounds. Suitable gaseous waste streams that may be treated have, in some embodiments, CO₂ present in amounts of 200 ppm to 1,000,000 ppm, such as 200,000 ppm to 1000 ppm, including 200,000 ppm to 2000 ppm, for example 180,000 ppm to 2000 ppm, or 180,000 ppm to 5000 ppm, also including 180,000 ppm to 10,000 ppm. Gas stream temperatures may also vary. In some embodiments, the temperature of the synthesis gas is from 0° C. to 2000° C., such as from 60° C. to 700° C., and including 100° C. to 400° C. Synthesis gas streams may be shifted or unshifted for use in this invention.

### Carbon Sequestering Reagents

In some embodiments, methods of the invention include contacting a volume of a reactive solution with a synthesis gas comprising CO₂ to form a CO₂ sequestering composition comprising carbonic acid, bicarbonate, carbonate, dissolved carbon dioxide or any combination thereof. The reactive solution may be any alkaline solution for example comprising KOH, NaOH, Mg(OH)₂, NaCO₃, or any combination thereof. In some embodiments the reactive solution may have a neutral or near neutral pH. The reactive solution may have a pH of 7 or greater such as greater than 8 or greater than 9 or greater than 10 or greater than 11 or 12 or greater than 13. In some embodiments the reactive solution contains magnesium or hydroxide. In some embodiments the reactive solution contains potassium. The reactive solutions of this invention may comprise chemical agents. Chemical agents for effecting proton removal generally refer to synthetic chemical agents produced in large quantities and are commercially available or electrochemically synthesized. For example, chemical agents for removing protons include, but are not limited to, hydroxides, organic bases, super bases, oxides, ammonia, borates and carbonates. Hydroxides include chemical species that provide hydroxide anions in solution, including, for example, sodium hydroxide (NaOH), potassium hydroxide (KOH), calcium hydroxide (Ca(OH)₂), or magnesium hydroxide (Mg(OH)₂). In some embodiments, the chemical proton-removing agent may be an organic base. In some instances, the organic base may be a monocarboxylic acid anion, e.g., formate, acetate, propionate, butyrate, and valerate, among others. In other instances, the reactive organic species may be a dicarboxylic acid anion, e.g., oxalate, malonate, succinate, and glutarate, among others. In other instances, the organic base may be a phenolic compound, e.g., phenol, methylphenol, ethylphenol, and dimethylphenol, among others. In some embodiments, the organic base may be a nitrogenous base, such as ammonia or a primary amine, e.g., methyl amine, a secondary amine, e.g., diisopropylamine, a tertiary amine, e.g., diisopropylethylamine, an aromatic amine, e.g., aniline, or a heteroaromatic, e.g., pyridine, imidazole, or benzimidazole. In some embodiments, the proton-removing agent is a super base. Suitable super bases may include, but are not limited to sodium ethoxide, sodium amide (NaNH₂), sodium hydride (NaH), butyl lithium, lithium diisopropylamide, lithium diethylamide, and lithium bis(trimethylsilyl)amide. Oxides including, for example, calcium oxide (CaO), magnesium oxide (MgO), strontium oxide (SrO), beryllium oxide (BeO), and barium oxide (BaO) may be also suitable proton-removing agents that may be used.

The sequestered CO₂ may be converted to compositions including precipitates or slurries. In some embodiments a reactive material may be used to transform a sequestered carbon dioxide into product comprising an alkali earth metal. The reactive material may comprise cations such as alkali earth metals (i.e., CaO, MgO, Mg(OH)₂ and the like). The reactive material may derived from an industrial waste stream. In addition to including cations of interest and other suitable metal forms, waste streams from various industrial processes may provide proton-removing agents. Such waste streams include, but are not limited to, mining wastes; fossil fuel burning ash (e.g., combustion ash such as fly ash, bottom ash, boiler slag); slag (e.g., iron slag, phosphorous slag); cement kiln waste; oil refinery/petrochemical refinery waste (e.g., oil field and methane seam brines); coal seam wastes (e.g., gas production brines and coal seam brine); paper processing waste; water softening waste brine (e.g., ion exchange effluent); silicon processing wastes; agricultural waste; metal finishing waste; high pH textile waste; and caustic sludge. Mining wastes include any wastes from the extraction of metal or another precious or useful mineral from the earth.

In some embodiments, industrial wastes or mined products may be used to modify pH and/or convert sequestered carbon dioxide into useful products. The wastes may be red mud from the Bayer aluminum extraction process; waste from magnesium extraction from seawater such as Mg(OH)₂ or MgO (e.g., wastes found in Moss Landing, Calif.). In some embodiments the MgO may be derived from brucite mines. In some embodiments the wastes from mining processes involving leaching may be utilized either to adjust the pH of a sequestering solution or as a reagent for forming a carbon sequestering product. For example, red mud may be used to modify pH. Fossil fuel burning ash, cement kiln dust, and slag, collectively waste sources of metal oxides may be used in alone or in combination with other proton-removing agents to provide proton-removing agents or reagents for the formation of products of this invention. Agricultural waste, either through animal waste or excessive fertilizer use, may contain potassium hydroxide (KOH) or ammonia (NH₃) or both. As such, agricultural waste may be used in some embodiments of the invention as a proton-removing agent or chemical reagent. This agricultural waste is often collected in ponds, but it may also percolate down into aquifers, where it may be accessed and used.

### Methods And Systems

During the gasification process a carbon containing fuel may be converted to synthesis gas (syn-gas). The synthesis gas may comprise hydrogen (H₂), carbon monoxide (CO), carbon dioxide CO₂, water and/or other components. During methods of this invention a synthesis gas may be contacted with a reactive solution to generate a product solution comprising carbonic acid, carbonate, bicarbonate or any combination thereof and a synthesis gas with a reduced carbon dioxide content. Either or both of the products of this reaction that may then be used as, or converted to, useful products. The synthesis gas may be converted into a solid or liquid fuel or any other material or be combusted directly to provide electricity. The synthesis gas may be converted to electricity using a power generating unit that consist of gas and steam turbines which may also include a heat recovery steam generator. In some embodiments the synthesis gas may be converted by any method (e.g. Fisher-Tropsch process) to other useful products such a synthetic liquid fuels, wax, or organic chemicals. In some embodiments integrated gasification combined cycle (IGCC) technology may be used to integrate the gasification process with combined cycle power plant. The synthesis gas generated during IGCC may contacted with a reactive solution to reduce the carbon dioxide content prior to combustion and then be combusted and used as fuel on a combined cycle power plant for electricity generation resulting in an exhaust gas with a reduced carbon dioxide content.

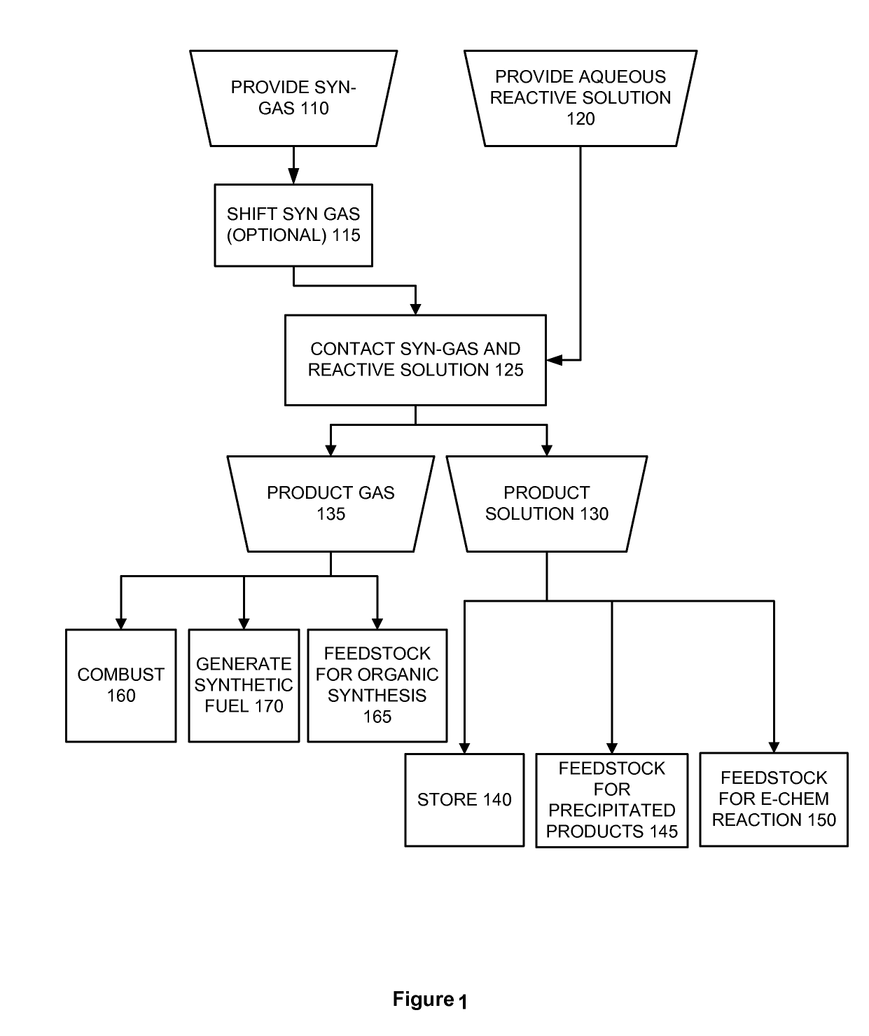

FIG. 1 shows the flow diagram of a general gasification technology with a carbon sequestration method of this invention. A synthesis gas may be generated by a gasification process 110. Syn-gases may or may not be processed through a shift reaction 115 to convert a portion of the carbon monoxide and water in the syn-gas into carbon dioxide and hydrogen. Shifted or unshifted synthesis gas may be contacted 125 with a reactive solution 120 to form a product solution 130 and a product gas 135. The reactive solution may be any solution that facilitates the transfer of carbon dioxide from the synthesis gas and into a solution. The sequestered carbon dioxide product solution 130 is suitable for further processing. The product solution may comprise bicarbonate, carbonate, aqueous carbon dioxide, carbonic acid or any combination thereof. The product solution may be stored (e.g., in an underground location) 140, or undergo a precipitation reaction to form a solid or slurry 145. The precipitation reaction may comprise contact with a cation (Na, Ca, Mg, or the like) or other precipitation reagent. In some embodiments a portion of the product solution may be utilized as a catholyte in an electrochemical reaction 150. In some embodiments the electrochemical reaction may generate all or a portion of the reactive solution. The product gas may be utilized as well. The product gas 135 will contain a reduced concentration of CO₂ relative to the starting synthesis gas and be suitable for combustion 160, or as a feedstock for any organic synthesis reaction 165 or for the generation a synthetic fuel 170 for later combustion.

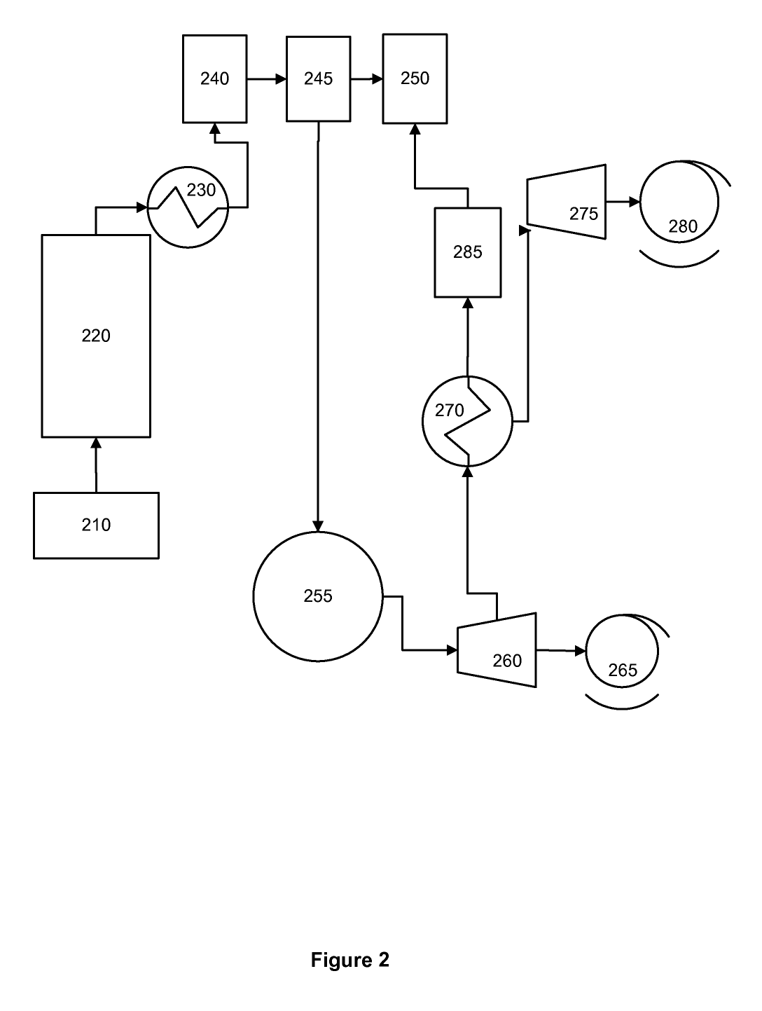

In some embodiments the synthesis gas may be made and utilized in an integrated gas combined cycle (IGCC) system. An illustration of an IGCC system of this invention is shown in FIG. 2 and may comprise 4-6 major sections, air separation, gasification, an optional heat exchange, an optional shift system, a carbon sequestration system, a combined cycle power plant and an optional additional carbon sequestration system. An air separation unit 210 may provide for supplying pure oxygen into the gasifier by separating air into its constituents. In some embodiments this process may be performed in a pressurized and cryogenic condition. In some embodiments fuel gasification may take place in the presence of a controlled air/oxygen steam which maintains a reducing condition. Gasification results from the partial oxidation of the feedstock which produces heat and series of chemical reactions. The process may be carried out in an enclosed pressurized reactor 220. Gasifiers may be oxygen blown to reduce the cost of handling large amounts of nitrogen and the effect that nitrogen has in diluting the product. The air blown gasifier is less preferable since its product has lower calorific value which is not desirable.

In addition to its chemical energy the hot raw synthesis gas contains sensible heat which may be recovered in heat exchangers to produce steam for the steam turbine or for any step of the carbon sequestration process. In some embodiments sensible heat from a heat exchanger 230 may be used to dry or dewater a sequestered carbon product. Energy from a steam turbine driven from heat recovered from heat exchangers may be used in an electrochemical reaction. The use of synthesis gas coolers for this purpose increases efficiency. In some embodiments the raw synthesis gas may be cleaned with or without cooling (as the sensible heat would be utilized most efficiently when delivered to the gas turbine).

In some embodiments the synthesis gas manufacturing process plant may include a pre-combustion stage such as a water gas shift reaction 240. In methods and systems of this invention CO₂ sequestration may occur with or without a water gas shift reaction. The addition of carbon sequestration methods and systems of this invention may increase the overall process efficiency relative to traditional carbon capture methods because traditional methods require additional power to compress the CO₂ that is captured. The sequestration methods of this invention advantageously do not require a CO₂ compression stage to make transportation and storage of sequestered of CO₂ feasible.

During the CO₂ sequestration process, particles, sulfur and other impurities may be removed in addition to CO₂ in a reaction vessel 245. CO₂ may be sequestered before or after the synthesis gas is cleaned of other impurities or optionally the carbon sequestration methods of this invention may also simultaneously remove any impurities that are desired. Because of the high partial pressures of the species such as carbon dioxide and impurities such as sulfur in addition to the low volume flow of synthesis gas, the gas cleanup and carbon sequestration processes may be beneficially more efficient than traditional flue gas cleaning Sequestered carbon dioxide may be processed separately in another reaction vessel 250.

The clean gas may be fed to the combined cycle power plant or processed in any way. A combined cycle power plant consists of a combustion vessel 255 turbine 260 and an electricity generator 265. The exhaust heat from the combustion turbine is recovered in the heat recovery steam generator 270 to produce steam. This steam then passes through a steam turbine 275 to power another generator 280, which produces more electricity. Combined cycle is more efficient than conventional power generating systems because it re-uses waste heat to produce more electricity. In some embodiments carbon dioxide may be additionally sequestered from flue gas after combustion of the synthesis gas in another carbon sequestration vessel 285. This may be most effective in cases where the synthesis gas was not shifted prior to carbon sequestration. The reactive solution used to sequester carbon dioxide in the first and second sequestration reactions may be the same or different.

Aspects of the invention also include methods for contacting a reactive solution with a first incoming synthesis gas comprising carbon dioxide to produce a first carbon containing reaction product (e.g., an aqueous solution comprising carbonic acid, bicarbonate, carbonate or combination thereof) and a reduced carbon dioxide containing product synthesis gas that may be that may be combusted or processed further. The products of synthesis gas processing or combustion may include a waste gas comprising carbon dioxide. This waste gas may also be contacted with a reactive carbon dioxide sequestering solution to form a second carbon containing reaction product. The reaction products may be clear liquids or precipitates and may have the same or a different compositions. In some embodiments the reaction products may be combined or kept separate. In some embodiments of methods of this invention, the incoming synthesis gas or waste gas comprises CO₂ at levels greater than those found in the atmosphere. In some embodiments the concentration of CO₂ found in synthesis gas used in this invention is greater than 2% 15%, 20%, 25%, 30% volume %. The absorbing reactive solutions may be alkaline solutions. In certain embodiments of the invention, a portion of any reaction product produced by contacting carbon dioxide with an reactive solution may be further placed in a location (e.g., in a in a subterranean site), effectively sequestering carbon dioxide in the form of any combination of a carbonic acid, bicarbonate and carbonate mixture. Alternatively, or in addition to sequestering the reaction product, the carbonic acid, bicarbonate, carbonate, carbonate compositions may further be contacted with a source of one or more proton-removing agents and/or a source of one or more divalent cations to produce a precipitated material comprising carbonates and/or bicarbonates. In some embodiments the reaction product may be further contacted with carbon dioxide to sequester a second portion of carbon dioxide. A portion of the reaction product material may be placed in a subterranean site or used as a commercial product (e.g., a building material). In some embodiments sequestering the reaction product may comprise placing the reaction product in a subterranean location.

As can be appreciated, other stable-storage carbonates and bicarbonate may be produced, including calcium and/or magnesium carbonate and/or bicarbonate, by adding the appropriate salt solution to replace the alkaline earth metals and preferentially precipitate the insoluble alkaline earth metal carbonate and/or bicarbonate over the more soluble alkaline metal carbonates and bicarbonates, as described in commonly assigned U.S. Pat. No. 7,735,274 supra hereby incorporated by reference in its entirety.

It will be appreciated that some sources of alkalinity contain carbonates, e.g., sodium carbonates. In such methods, a reaction may be carried (V) out in which carbon dioxide is added to carbonate source of alkalinity, resulting in the formation of bicarbonate:

Na₂CO₃+CO₂+H₂O→2 NaHCO₃ (V)

Some or all of the sequestered carbon dioxide may be disposed of, e.g., by injection into a subterranean location, in may be any suitable location. In some embodiments over 10, 20, 30, 40, 50, 60, 70, 80, 90, 95, 99% of the sequestered carbon dioxide product formed, or 100% of the sequestered carbon dioxide product formed, may be disposed of this way. Alternatively, or in addition, some portion of the sequestered carbon dioxide may be further treated, e.g., with a base or additional carbonate or a divalent cation, to form a precipitate. In some embodiments one or more divalent cations, such as magnesium and/or calcium, may be present and a carbonate of the divalent cation may form, e.g., calcium or magnesium carbonate; typically such a carbonate of the divalent cation will precipitation from the solution. It will be appreciated that in such a system one mole of base (e.g., hydroxide) may be used to produce one mole of carbonate (e.g., magnesium and/or calcium carbonate). The amount of base added may be any desired amount, so that any proportion, from 0 to 100%, of the original carbon dioxide that is sequestered in the aqueous solution may be converted to carbonate and the remainder, (100-0)% remains in the form of bicarbonate, in a process using base for the final conversion to carbonate in a ratio of 1 equivalent of base per each mole of carbonate produced. For example an amount of base may be added sufficient to result in carbonate and bicarbonate in a final molar % ratio of bicarbonate:carbonate of from 0.1:99.9 to 99.9:0.1, or 1:99 to 99:1, or 10:90 to 90:10, or 20:80 to 80:20, or 30:70 to 70:30, or 40:60 to 60:40, or about 50:50. By way of illustration only, in a system or method in which 10 moles of carbon dioxide are dissolved in a carbonate solution, e.g., to produce 20 moles of bicarbonate (10 moles from the original carbonate and 10 moles from the dissolved carbon dioxide), an additional 5 moles of NaOH (5 equivalents) may be added together with at least 5 moles of calcium and/or magnesium ion, which converts 5 moles of the bicarbonate to insoluble calcium and/or magnesium carbonate and leaves 15 moles of bicarbonate in solution (a 75:25% ratio of bicarbonate to carbonate). Thus, in some embodiments the invention provides a method of treating a gas containing carbon dioxide by contacting the gas with a first aqueous reactive solution, e.g., sodium carbonate, hydroxide, to produce a bicarbonate and or carbonate solution from the carbon dioxide, followed by processing of the remaining gas in any way. After processing, a waste gas may be formed that may be reacted with a second aqueous reactive solution. The systems and methods of this invention beneficially provide for regulating the amount and composition of sequestered carbon dioxide products.

In some embodiments a product solution of this invention may comprise bicarbonate. The bicarbonate product of this invention may be stored or converted into a useful product. In some embodiments the bicarbonate solution may be treated with an amount of base, e.g., hydroxide, and divalent cation, e.g., calcium or magnesium ion, sufficient to convert a portion of the bicarbonate thus produced to an insoluble carbonate, e.g., magnesium and/or calcium carbonate. The ratio of bicarbonate and carbonate in the final product may be varied depending on any suitable factor, such as the availability and/or cost of base, so that, e.g., more carbonate may be produced when base is cheaper and less when base is more expensive; the system or method may be set up to automatically adjust the ratios according to one or more criterion such as base cost, amount of electricity available to produce base, demand for carbonate products, and the like. The insoluble carbonate may be further treated, as describe herein, e.g., to produce materials useful in building and construction.

A portion of the bicarbonate solution may be converted to a solution comprising carbonate by an electrochemical method, e.g., a low-voltage electrochemical method such as a method wherein a voltage is applied across an anode and a cathode, and hydrogen gas is produced at the cathode and consumed at the anode, and hydroxide is produced at the cathode and protons at the anode. The carbonate solution may be used to sequester still more carbon dioxide. Combinations of any of the above mentioned sources of proton-removing agents and methods for effecting proton removal may also be employed.

By “CO₂ sequestering storage stable composition” is meant a product that removes or segregates an amount of CO₂ from an environment, such as the Earth's atmosphere or a gaseous waste stream produced by an industrial plant, so that some or all of the CO₂ is no longer present in the environment from which it has been removed. By “storage stable” is meant a form that can be stored, for example above ground or underwater, under exposed conditions (for example, open to the atmosphere, underwater environment, etc.), without significant, if any, degradation for extended durations, e.g., 1 year or longer, 5 years or longer, 10 years or longer, 25 years or longer, 50 years or longer, 100 years or longer, 250 years or longer, 1000 years or longer, 10,000 years or longer, 1,000,000 years or longer, or 100,000,000 years or longer, or 1,000,000,000 years or longer. As the storage stable form undergoes little if any degradation, the amount of degradation if any as measured in terms of CO₂ gas release from the product will not exceed 5%/year, and in certain embodiments will not exceed 1%/year or 0.001% per year. CO₂ sequestering methods of the invention sequester CO₂ producing a storage stable carbon dioxide sequestering product from an amount of CO₂, such that the CO₂ from which the product is produced is then sequestered in that product. The storage stable CO₂ sequestering product is a storage stable composition that incorporates an amount of CO₂ into a storage stable form, such as an above-ground storage or underwater storage stable form, so that the CO₂ is no longer present as, or available to be, a gas in the atmosphere. The sequestered carbon dioxide solutions, which include sequestered CO₂ bicarbonate, carbonate, carbonic acid or any combination thereof, may, in some embodiments, be transported to a location for long-term storage, effectively sequestering the CO₂. For example, the CO₂-sequestered storage stable reaction mixture may be transported and placed at long term storage sites, e.g., above ground, below ground in the deep ocean, or as desired.

### Electrochemical Methods

Electrochemical methods are another means to remove protons from various species in a solution. Electrochemical methods may be used to produce caustic molecules (e.g., hydroxide) through, for example, the chlor-alkali process, or modifications thereof. In some embodiments electrochemical systems and methods for removing protons may produce an acidic solution in a separate compartment that may be harvested and used for other purposes. Additional electrochemical approaches that may be used in systems and methods of the invention include, but are not limited to, those described in U.S. patent application Ser. No. 12/344,019, filed 24 Dec. 2008; U.S. patent application Ser. No. 12/375,632, filed 23 Dec. 2008, International Patent Application No. PCT/US08/088242, filed 23 Dec. 2008; International Patent Application No. PCT/US09/32301, filed 28 Jan. 2009; International Patent Application No. PCT/US09/48511, filed 24 Jun. 2009; U.S. patent application Ser. No. 12/541,055 filed 13 Aug. 2009; and U.S. patent application Ser. No. 12/617,005, filed 12 Nov. 2009, the disclosures of which are incorporated herein by reference in their entirety. Combinations of any of the above mentioned sources of proton-removing agents and methods for effecting proton removal may also be employed.

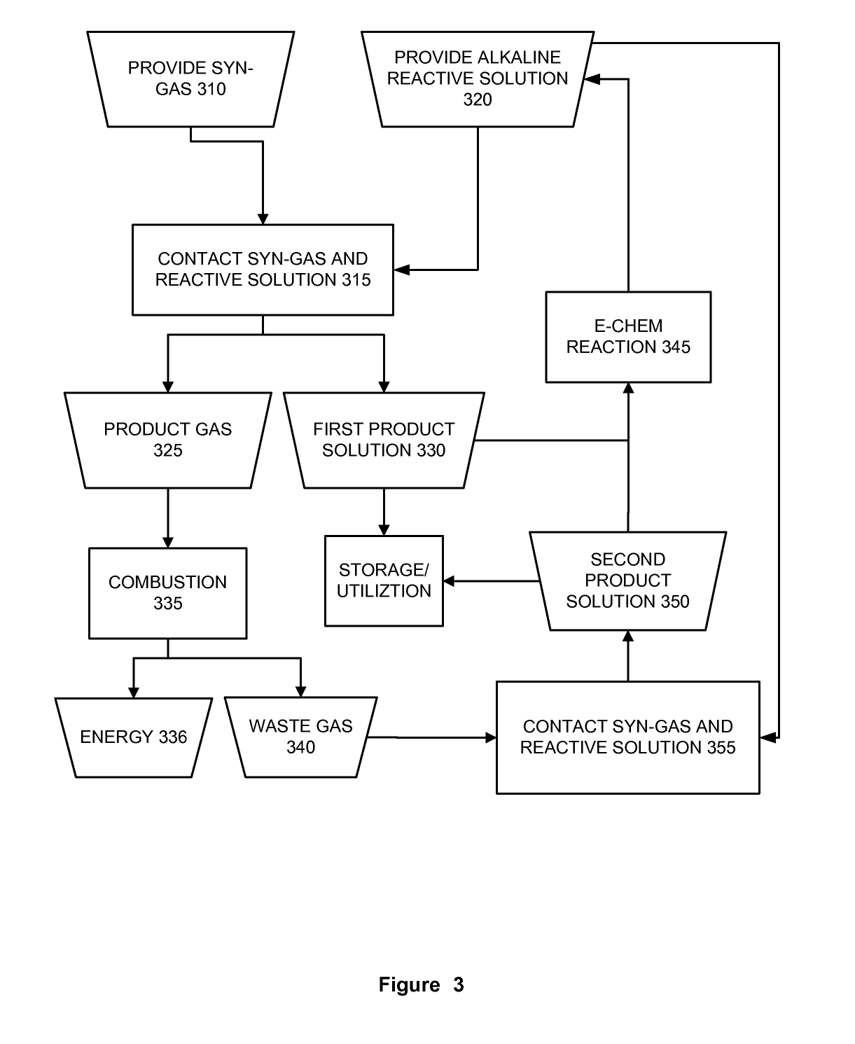

In FIG. 3 an embodiment of this invention is illustrated wherein an electrochemical method may be utilized to generate an alkaline reactive solution for carbon dioxide sequestration either from a synthesis gas or from a synthesis gas in combination with a waste gas. In some embodiments a synthesis gas 310 may be contacted 315 with a reactive alkaline solution 320 to form a first product solution 330 and a product synthesis gas 325 that is then processed further. The further process (e.g., combustion 335) may generate energy 336 and a waste gas 340 that comprises carbon dioxide. In some embodiments the waste gas may be contacted 355 with the alkaline reactive solution 320 as well, in order to sequester even more carbon dioxide

In some embodiments an electrochemical reaction 345 may be used to generate all or part of an alkaline reactive solution 320 that comprises carbonates and that may be reacted 315, 355 with the carbon dioxide in the synthesis gas 310 or the waste gas 340 to form a sequestered carbon dioxide first product solution 330 or second product solution 350. In some embodiments the alkaline reactive solution may be contacted with the synthesis gas or the waste gas to form product solutions that comprise bicarbonates. The first and second product solution may remain separate or be combined. The product solutions may be stored and/or a portion may be recycled into the electrochemical reaction 345 to regenerate the alkaline solution 320for additional sequestration or storage.

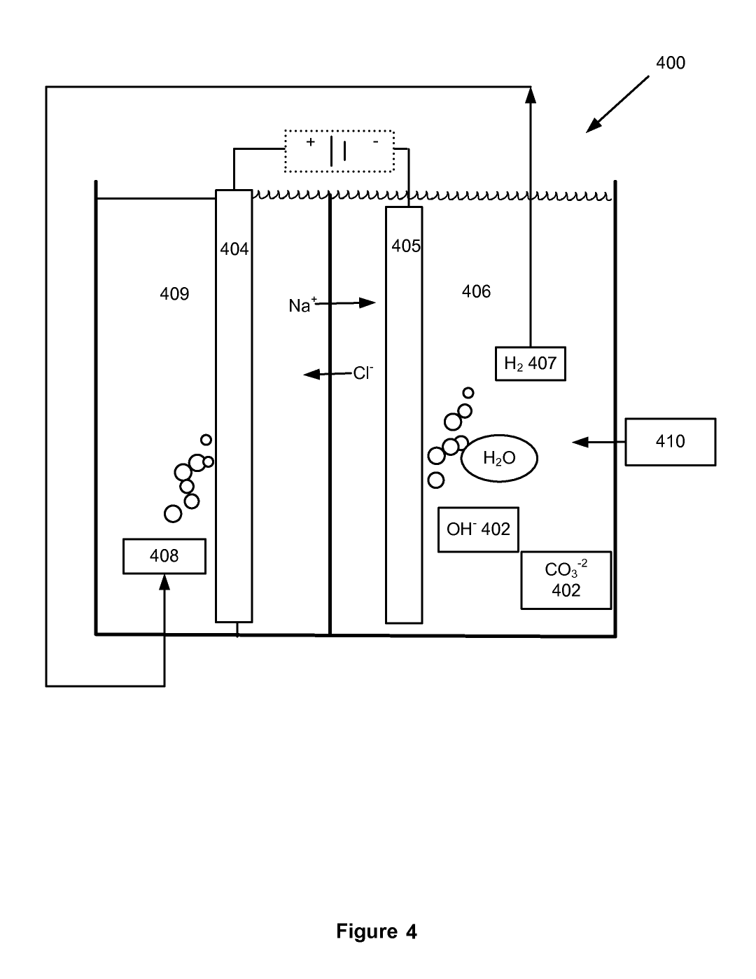

Any electrochemical method may be utilized in methods of this invention. In some embodiments alkaline hydroxides or carbonates may be produced electrochemically from an aqueous salt solution. An embodiment of a system is described with reference to FIG. 4 herein. A proton removing agent 402 (e.g., hydroxide, carbonate) is produced by an electrochemical system 400 wherein in one embodiment at the cathode 405, the catholyte 406 is reduced to a proton removing agent 402 and hydrogen gas 407 that may migrate into the catholyte 406. In some embodiments the hydrogen may be transferred to the anolyte 409 and at the anode 404, hydrogen gas 408 is oxidized. In some embodiments carbon dioxide or bicarbonate 410 is added to the catholyte to lower the cell voltage across the anode and cathode, and also to produce bicarbonate and/or carbonate solution with the catholyte. The carbon dioxide or bicarbonate may be added in a compartment separate from the cathode compartment when the compartments are operably connected

In some embodiments, an aqueous salt solution, e.g., sodium chloride or sodium sulfate solution is electrolyzed to produce the alkaline solution comprising hydroxide ions in the catholyte in contact with the cathode, and hydrogen gas at the cathode, while minimizing or eliminating the production of chlorine gas. Concurrently, protons produced by the oxidation at the anode migrate into the anolyte in contact with the anode to produce an acid, e.g., hydrochloric acid or sulfuric acid with cations from the salt solution. The system and method may be configured to operate at a voltage of 2.0 volts or less (e.g., less than 1.8 or 0.6 volts,) applied across the anode and the cathode. Industrial amounts of an alkaline solution may be produced in electrochemical systems based on the chlor-alkali process or in a process that do not involve the generation of chlorine. Methods and systems used in sequestering carbon dioxide include sodium hydroxide produced in an electrochemical process e.g., from a sodium chloride solution or sodium sulfate. In one embodiment of the electrochemical process, as described in commonly assigned U.S. Pat. No. 7,790,012 herein incorporated by reference, sodium hydroxide is produced in the cathode compartment and migration of sodium ions from the salt solution into the cathode compartment to produce sodium hydroxide in the catholyte in contact with the cathode as shown in equation VI.

2H₂O+2e⁻→H₂+2OH⁻ (Eq. VI)

In some embodiments the co-product hydrogen gas produced at the cathode may be recovered and used at the anode as described below. In the anode compartment, depending on which oxidation reaction occurs at the anode, either chlorine gas or hydrochloric acid may be produced based on equations VII and VIII.

2Cl⁻→Cl₂+2e- (Eq. VII)

H₂→2H⁺+2e- (Eq. VIII)

Where chlorine gas is produced as in Eq. VII, the gas can be recovered and used elsewhere; and where hydrogen is oxidized at the anode as in Eq. VIII, the hydrogen gas produced at the cathode as in Eq. VII may be used at the anode. Alternatively, hydrogen from an exogenous source may be used. In some embodiments hydrogen is oxidized to protons at the anode under the applied overall cell voltage, the protons migrate into the anolyte in contact with the anode and combine with chloride ions to produce hydrochloric acid. As used herein, the anolyte is the electrolyte in contact with the anode, and the catholyte is the electrolyte in contact with the cathode; thus the anolyte may migrate or supply anions to or from the anode and similarly the catholyte can migrate or supply ions to or from the cathode.

One means by which the overall cell voltage may be reduced is not to produce a gas (e.g., chlorine, oxygen) at the anode, but rather to oxidize hydrogen at the anode to yield an acid. The methods of this invention provide for utilizing acid produced by an electrochemical process described here to advantageously further increase the economic efficiency of the process. In some embodiments, the hydrogen produced at the cathode may circulated to the anode to reduce the need for an external supply of hydrogen gas and hence reduce the overall energy utilized in the system to produce the alkaline solution.

In some embodiments, the sodium hydroxide is produced in the cathode electrolyte. When a voltage of less than 2 or less than 1.5, 1.4, 1.3, 1.2, 1.1, or 1.0 volts is applied across the cathode and anode. Concurrently, the hydrogen provided to the anode is oxidized to protons that migrate in the anolyte to produce an acid, e.g., hydrochloric acid or sulfuric acid in the anolyte. In methods of this invention utilization methods are described that may provide for increased economic efficiency of the electrochemical reaction.

In another embodiment, the present hydrogen anode assembly is described in greater detail in U.S. Pat. No. 5,595,641, titled: “Apparatus and Process for Electrochemically Decomposing Salt Solutions to form the Relevant Base and Acid”, herein incorporated by reference. In some embodiments, an electrolyzer comprising at least one elementary cell divided into electrolyte compartments by cation-exchange membranes, wherein said compartments are provided with a circuit for feeding electrolytic solutions and a circuit for withdrawing electrolysis products, and wherein said cell is equipped with a cathode and a hydrogen-depolarized anode assembly forming a hydrogen gas chamber fed with a hydrogen-containing gaseous stream, characterized in that said assembly comprises a cation-exchange membrane, a porous, flexible electrocatalytic sheet, a porous rigid current collector having a multiplicity of contact points with said electrocatalytic sheet, said membrane, sheet and current collector are held in contact together by means of pressure without bonding.

### Precipitation

Methods of the invention may include contacting a volume of an aqueous solution of divalent cations with a source of sequestered carbon dioxide (e.g., carbonic acid, bicarbonate, and/or carbonate) in a product solution and subjecting the resultant solution to precipitation conditions. In addition to divalent cations sourced from acid neutralizing material, divalent cations may come from any of a number of different divalent cation sources depending upon availability at a particular location. Material comprising divalent cations may also be used in combination with supplemental sources of divalent cations. Such sources include industrial wastes, seawater, subterranean brines, hard waters, minerals (e.g., lime, periclase), and any other suitable source.

In methods of the invention, a volume of CO₂-charged product solution produced as described above may be subjected to carbonate compound precipitation conditions sufficient to produce a carbonate-containing precipitation material and a supernatant (i.e., the part of the precipitation reaction mixture that is left over after precipitation of the precipitation material). Any convenient precipitation condition may be employed, in which conditions result in production of a carbonate-containing precipitation material. In some embodiments the materials may comprise divalent cations from a metal silicate (optionally with SiO₂) from the CO₂-charged reaction mixture. Precipitation conditions include those that modulate the physical environment of the CO₂-charged precipitation reaction mixture to produce the desired precipitation material. For example, the temperature of the CO₂-charged precipitation reaction mixture may be raised to a point at which precipitation of the desired carbonate-containing precipitation material occurs, or a component thereof (e.g., CaSO₄(s), the sulfate resulting from, for example, sulfur-containing gas in combustion gas or sulfate from seawater). In such embodiments, the temperature of the CO₂-charged precipitation reaction mixture may be raised to a value from 5° C. to 70° C., such as from 20° C. to 50° C., and including from 25° C. to 45° C. While a given set of precipitation conditions may have a temperature ranging from 0° C. to 100° C., the temperature may be raised in certain embodiments to produce the desired precipitation material. In certain embodiments, the temperature of the precipitation reaction mixture is raised using energy generated from low or zero carbon dioxide emission sources (e.g., solar energy source, wind energy source, hydroelectric energy source, waste heat from the flue gases of the carbon dioxide emitter, etc.). In some embodiments, the temperature of the precipitation reaction mixture may be raised utilizing heat from flue gases from coal or other fuel combustion. Pressure may also be modified. In some embodiments, the pressure for a given set of precipitation conditions is normal atmospheric pressure (about 1 bar) to about 50 bar. In some embodiments, the pressure for a given set of precipitation materials is 1-2.5 bar, 1-5 bar, 1-10 bar, 10-50 bar, 20-50 bar, 30-50 bar, or 40-50 bar. In some embodiments, precipitation of precipitation material is performed under ambient conditions (i.e., normal atmospheric temperature and pressure). The pH of the CO₂-charged precipitation reaction mixture may also be raised to an amount suitable for precipitation of the desired carbonate-containing precipitation material. In such embodiments, the pH of the CO₂-charged precipitation reaction mixture is raised to alkaline levels for precipitation, wherein carbonate is favored over bicarbonate. The pH may be raised to pH 9 or higher, such as pH 10 or higher, including pH 11 or higher. For example, when a proton-removing agent source such as fly ash is used to raise the pH of the precipitation reaction mixture or precursor thereof, the pH may be about pH 12.5 or higher.

Accordingly, a set of precipitation conditions to produce a desired precipitation material from a precipitation reaction mixture may include, as above, the temperature and pH, as well as, in some instances, the concentrations of additives and ionic species in solution. Precipitation conditions may also include factors such as mixing rate, forms of agitation such as ultrasonic agitation, and the presence of seed crystals, catalysts, membranes, or substrates. In some embodiments, precipitation conditions include supersaturated conditions, temperature, pH, and/or concentration gradients, or cycling or changing any of these parameters. The protocols employed to prepare carbonate-containing precipitation material according to the invention (from start to finish [e.g., drying precipitation material or forming precipitation material into pozzolanic material]) may be batch, semi-batch, or continuous protocols. It will be appreciated that precipitation conditions may be different to produce a given precipitation material in a continuous flow system compared to a semi-batch or batch system.

Carbonate-containing precipitation material, following production from a precipitation reaction mixture, may be separated from the reaction mixture to produce separated precipitation material (e.g., wet cake) and a supernatant. Precipitation material according to the invention may contain SiO₂; however, if silicon-based material was separated after digestion of material comprising metal silicates, the precipitation may contain very little or no SiO₂. The precipitation material may be stored in the supernatant for a period of time following precipitation and prior to separation (e.g., by drying). For example, the precipitation material may be stored in the supernatant for a period of time ranging from 1 to 1000 days or longer, such as 1 to 10 days or longer, at a temperature ranging from 1° C. to 40° C., such as 20° C. to 25° C. Separation of the precipitation material from the precipitation reaction mixture is achieved using any of a number of convenient approaches, including draining (e.g., gravitational sedimentation of the precipitation material followed by draining), decanting, filtering (e.g., gravity filtration, vacuum filtration, filtration using forced air), centrifuging, pressing, or any combination thereof. Separation of bulk water from the precipitation material produces a wet cake of precipitation material, or a dewatered precipitation material. As detailed in U.S. 61/170,086, filed Apr. 16, 2009, which is herein incorporate by reference, use of liquid-solid separators such as Epuramat's Extrem-Separator (“ExSep”) liquid-solid separator, Xerox PARC's spiral concentrator, or a modification of either of Epuramat's ExSep or Xerox PARC's spiral concentrator, provides for separation of the precipitation material from the precipitation reaction mixture.

In some embodiments, the resultant dewatered precipitation material may then dried to produce a product (e.g., a cement, or a pozzolanic cement). Drying may be achieved by air-drying the precipitation material. Where the precipitation material is air dried, air-drying may be at a temperature ranging from −70° C. to 120° C. In certain embodiments, drying is achieved by freeze-drying (i.e., lyophilization), wherein the precipitation material is frozen, the surrounding pressure is reduced, and enough heat is added to allow the frozen water in the precipitation material to sublime directly into gas. In yet another embodiment, the precipitation material is spray-dried to dry the precipitation material, wherein the liquid containing the precipitation material is dried by feeding it through a hot gas (e.g., a gaseous waste stream from the power plant), and wherein the liquid feed is pumped through an atomizer into a main drying chamber and a hot gas is passed as a co-current or counter-current to the atomizer direction. Depending on the particular drying protocol, the drying station (described in more detail below) may be configured to allow for use of a filtration element, freeze-drying structure, spray-drying structure, etc. In certain embodiments, waste heat from a power plant or similar operation may be used to perform the drying step when appropriate. For example, in some embodiments, aggregate is produced by the use of elevated temperature (e.g., from power plant waste heat), pressure, or a combination thereof.

Following separation of the precipitation material from the supernatant, the separated precipitation material may be further processed as desired; however, the precipitation material may simply be transported to a location for long-term storage, effectively sequestering CO₂. For example, the carbonate-containing precipitation material may be transported and placed at a long-term storage site, for example, above ground (as a storage-stable CO₂-sequestering material), below ground, in the deep ocean, etc.

In some embodiments divalent cations may be contacted with sequestered carbon dioxide to produce precipitation material. In some embodiments, the method further comprises separating the precipitation material from the supernatant with a liquid-solid separator, drying the precipitation material, processing the precipitation material to produce a construction material, or a combination thereof. As such, in some embodiments, the method further comprises separating the precipitation material from the supernatant with a liquid-solid separator. In such embodiments, the liquid-solid separator is selected from a liquid-solid separator comprising a baffle such as Epuramat's Extreme-Separator (“ExSep”) liquid-solid separator. For example, in some embodiments, precipitation material is separated from precipitation reaction mixture by flowing the reaction mixture against a baffle, against which supernatant deflects and separates from particles of precipitation material, which is collected in a collector. In some embodiments, the liquid-solid separator is selected from a liquid-solid separator comprising a spiral concentrator such as Xerox PARC's spiral concentrator. For example, in some embodiments, precipitation material is separated from precipitation reaction mixture by flowing the reaction mixture in a spiral channel separating particles of precipitation material from supernatant and collecting the precipitation material in an array of spiral channel outlets. In some embodiments, the method further comprises drying the precipitation material. In such embodiments, the precipitation material may be dried to form a fine powder having a consistent particle size (i.e., the precipitation material may have a relatively narrow particle size distribution). Precipitation material, as described further herein, may have a Ca²⁺ to Mg²⁺ ranging from 1:1000 to 1:1 or 1 to 1000:1. Precipitation material comprising MgCO₃ may comprise magnesite, barringtonite, nesquehonite, lansfordite, amorphous magnesium carbonate, artinite, hydromagnesite, or a combination thereof. Precipitation material comprising CaCO₃ may comprise calcite, aragonite, vaterite, ikaite, amorphous calcium carbonate, monohydrocalcite, or combinations thereof. In some embodiments the precipitation material may be greater that 50% vaterite. In some embodiments, the method further comprises processing the precipitation material to produce a construction material. In such embodiments, the construction material is an aggregate, cement, cementitious material, supplementary cementitious material, or a pozzolan.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any design features developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A method comprising:
a) contacting a synthesis gas stream with a first reactive solution to form a product solution and a product gas with a reduced carbon dioxide concentration wherein the product solution comprises carbonate, bicarbonate or any combination thereof;
b) utilizing a portion of the product solution as a catholyte in an electrochemical reaction; and
c) processing the product gas.

2. The method of claim 1 wherein the product of the electrochemical reaction is the first reactive solution.

3. The method of claim 1, wherein the first reactive solution comprises hydroxide ions.

4. The method of claim 1, wherein processing the product gas comprises combusting the product gas to form a waste gas comprising second portion of CO₂; and contacting the waste gas with second reactive solution to form a second product gas with a CO₂ concentration lower than the CO₂ concentration of the waste gas and a second product solution that comprises carbonate, bicarbonate or any combination thereof.

5. The method of claim 1, further comprising steam shifting the synthesis gas prior to contacting the synthesis gas with the reactive solution.

6. The method of claim 4, wherein the first reactive solution comprises carbonates and the second reactive solution comprises ⁻OH.

7. The method of claim 1, wherein contacting the synthesis gas stream comprises removing 75% or more of the carbon dioxide from the synthesis gas stream.

8. The method of claim 1, further comprises producing a carbonate-containing precipitation material from the product solution.

9. The method of claim 8, wherein producing a carbonate-containing precipitation material comprises subjecting the product solution to precipitation conditions to produce a carbonate-containing precipitation material and depleted aqueous composition.

10. The method of claim 8, wherein the carbonate-containing precipitation material comprises aragonite, vaterite, amorphous calcium carbonate, trona, or any combination thereof.

11. The method of claim 10, wherein the method further comprises processing the carbonate-containing precipitation material to produce a building material.

12. The method of claim 11, wherein the building material is selected from the group consisting of hydraulic cement, a supplementary cementitious material and aggregate.

13. A system for separating carbon dioxide from a synthesis gas stream comprising:
a) a gasifier configured to produce a synthesis gas operably connected to a source of a carbonaceous fuel;
b) a gas-liquid absorption system operably connected to the gasifier and comprising an inlet for a reactive solution, an inlet for the synthesis gas, an outlet for a product gas with a reduced carbon dioxide content, and an outlet for a product solution comprising carbon dioxide; and
c) an electrochemical system operably connected to the gas-liquid absorption system configured to generate the reactive solution suitable for sequestering carbon dioxide from a synthesis gas.

14. The system of claim 13, wherein the electrochemical system comprises a conduit system configured to transport the reactive solution from the electrochemical system to the gas-liquid absorption system.

15. The system of claim 13, further comprising a precipitation system operably connected to the gas-liquid absorption system.

16. The system of claim 13, wherein the electrochemical system comprises an anode in contact with a first electrolyte and a cathode in contact with a second electrolyte and wherein the electrochemical system is configured to apply a voltage across the anode and cathode to produce hydroxide ions in the second electrolyte without forming oxygen or chlorine at the anode.

17. The system of claim 16, wherein the second electrolyte comprises sodium chloride.

18. The system of claim 13, wherein the system further comprises a detector configured to determine energy consumption of the system.

19. The system of claim 13, wherein the system further comprises a carbonate-compound production station configured to produce a carbonate-containing precipitation material and depleted aqueous composition.

20. The system of claim 13, wherein the carbonate-compound production station comprises a liquid-solid separator.
